(19) United States
(12) Patent Application Publication
(10) Pub. No.: US 2018/0144657 A1
(43) Pub. Date: May 24, 2018

(54) LEARNING ASSISTANCE APPARATUS, LEARNING ASSISTANCE METHOD, AND COMPUTER-READABLE STORAGE MEDIUM

(71) Applicants: NEC Solution Innovators, Ltd., Tokyo (JP); KEIO UNIVERSITY, Tokyo (JP)

(72) Inventors: Dai KUSUI, Tokyo (JP); Hideo SHIMAZU, Tokyo (JP); Atsushi SHINJO, Kanagawa (JP)

(73) Assignees: NEC Solution Innovators, Ltd., Tokyo (JP); KEIO UNIVERSITY, Tokyo (JP)

(21) Appl. No.: 15/814,890

(22) Filed: Nov. 16, 2017

(30) Foreign Application Priority Data
Nov. 18, 2016 (JP) 2016-224813

(51) Int. Cl. G09B 7/08; G09B 19/00

(52) U.S. Cl. CPC G09B 7/08; G09B 19/003

(57) ABSTRACT

A learning assistance apparatus 10 includes a video presentation unit 11 that presents a first video of a first person performing a specific agricultural task and a second video of a second person performing a specific agricultural task, an inquiry processing unit 12 that presents, to a user, questions regarding disparities between the agricultural task of the first person in the first video and the agricultural task performed by the second person in the second video and receives a response by the user, and an educational material suggestion unit 13 that specifies an educational material for describing the specific agricultural task based on a result of the response and suggests the specified educational material.

### CROSS-REFERENCE TO RELATED APPLICATION

This application is based upon and claims the benefit of priority from Japanese patent application No. 2016-224813, filed on Nov. 18, 2016, the disclosure of which is incorporated herein in its entirety by reference.

### BACKGROUND OF THE INVENTION

### 1. Field of the Invention

The present invention relates to a learning assistance apparatus and a learning assistance method for assisting learning by suggesting educational materials that are optimal for when learning agriculture, and furthermore relates to a computer-readable storage medium storing a program for realizing the learning assistance apparatus and the learning assistance method.

### 2. Background Art

Conventionally, many books describing various agricultural tasks in the agriculture field have been published. For example, Document 1 discloses know-how with a focus on the most important pruning in mandarin orange production. Also, Document 2 discloses know-how relating to pest control for fruit trees. Furthermore, Document 3 discloses know-how relating to tomato farming using photographs and illustrations, with a focus on fertilizer addition, watering, hormone treatment, and the like.

Thus, according to Documents 1 to 3, a producer can acquire know-how relating to agricultural tasks without studying under an expert. Accordingly, even a producer with little experience can ensure some amount of yield in the production of a crop. Also, many other books describing agricultural tasks have been published in addition to Documents 1 to 3.

Document 1: Kawata, Kenji “Growing High-Sugar-Content Re-bred Mandarin Oranges—Pruning and Rat's Tail Fescue Grass Farming”, Rural Culture Association Japan, April 2002

Document 2: Tashiro, Nobuya “Pest Control For Fruit Trees—Done Easily and With Reduced Pesticides”, Rural Culture Association Japan, September 2007

Document 3: Goto, Satomi “New Edition Summer and Fall Tomato Farming Manual: Viewpoints and Methods for Growing that Anyone Can Do”, Rural Culture Association Japan, Mar. 12, 2015

However, since there are very many types of agricultural tasks for each crop and each region, it is difficult in some cases to understand an agricultural task through a description given by means of text or photographs in a book. Also, it is difficult even for an experienced person to know how to give a description of an agricultural task so that it is easy to understand. For this reason, in developing the agriculture field, it is important to solve the above-described problem and to provide suitable types of educational materials for learning agricultural tasks.

### SUMMARY OF THE INVENTION

An example of an object of the present invention is to provide a learning assistance apparatus, a learning assistance method, and a program, according to which it is possible to provide a suitable type of educational material for learning an agricultural task.

In order to achieve the above-described object, a learning assistance apparatus according to an aspect of the present invention includes:

a video presentation unit configured to present a first video of a first person performing a specific agricultural task and a second video of a second person performing the specific agricultural task;

an inquiry processing unit configured to present, to a user, questions regarding disparities between the agricultural task of the first person in the first video and the agricultural task performed by the second person in the second video, and receive a response of the user; and

an educational material suggestion unit configured to specify a type of educational material for describing the specific agricultural task based on the result of the response, and suggest the specified type of educational material.

In order to achieve the above-described object, a learning assistance method according to an aspect of the present invention includes:

(a) a step of presenting a first video of a first person performing a specific agricultural task and a second video of a second person performing the specific agricultural task;

(b) a step of presenting, to a user, questions regarding disparities between the agricultural task of the first person in the first video and the agricultural task performed by the second person in the second video, and receiving a response of the user; and

(c) a step of specifying a type of educational material for describing the specific agricultural task based on the result of the response, and suggesting the specified type of educational material.

Furthermore, in order to achieve the above-described object, a computer-readable storage medium according to an aspect of the present invention stores a program including commands for causing a computer to execute:

(a) a step of presenting a first video of a first person performing a specific agricultural task and a second video of a second person performing the specific agricultural task;

(b) a step of presenting, to a user, questions regarding disparities between the agricultural task of the first person in the first video and the agricultural task performed by the second person in the second video, and receiving a response of the user; and

(c) a step of specifying a type of educational material for describing the specific agricultural task based on the result of the response, and suggesting the specified type of educational material.

As described above, according to the present invention, it is possible to suggest a suitable type of educational material for learning an agricultural task.

### BRIEF DESCRIPTION OF THE DRAWINGS

FIG. 1 is a block diagram showing a schematic configuration of a learning assistance apparatus according to an embodiment of the present invention.

FIG. 2 is a block diagram showing a specific configuration of a learning assistance apparatus according to an embodiment of the present invention.

FIG. 3 is a diagram showing an example of first and second videos displayed on a terminal apparatus of a user in the present embodiment.

FIG. 4 is a flow diagram showing operations of a learning assistance apparatus according to an embodiment of the present invention.

FIG. 5 is a block diagram showing an example of a computer that realizes a learning assistance apparatus according to an embodiment of the present invention.

### EXEMPLARY EMBODIMENTS

### Embodiment

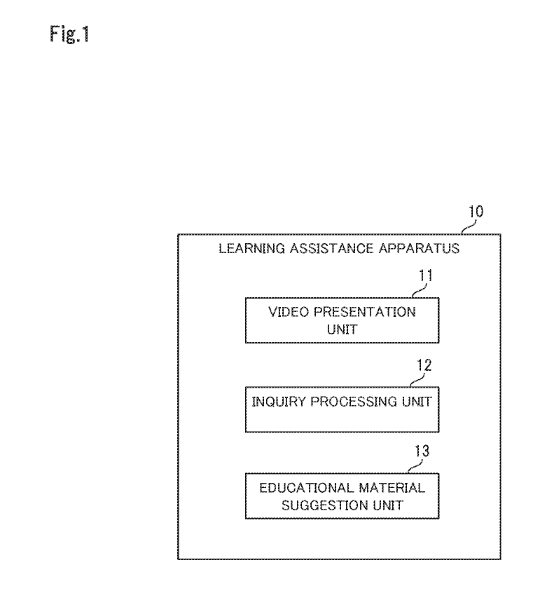

Hereinafter, a learning assistance apparatus, a learning assistance method, and a program according to an embodiment of the present invention will be described with reference to FIGS. 1 to 5.

### Configuration of Apparatus

First, a schematic configuration of a learning assistance apparatus of the present embodiment will be described with reference to FIG. 1. FIG. 1 is a block diagram showing a schematic configuration of a learning assistance apparatus according to an embodiment of the present invention.

The learning assistance apparatus 10 according to the present embodiment, which is shown in FIG. 1, is an apparatus that suggests an optimal educational material for when learning agriculture and thereby assists learning. As shown in FIG. 1, the learning assistance apparatus 10 includes a video presentation unit 11, an inquiry processing unit 12, and an educational material suggestion unit 13.

The video presentation unit 11 presents a first video of a first person performing a specific agricultural task and a second video of a second person performing the specific agricultural task. The inquiry processing unit 12 presents the user with questions regarding disparities between the agricultural task of the first person in the first video and the agricultural task performed by the second person in the second video, and furthermore receives a response from the user. The educational material suggestion unit 13 specifies a type of educational material for describing the specific agricultural task based on the result of the received response and suggests the specified type of educational material.

In this way, with the present embodiment, the learning assistance apparatus 10 can collect the disparity between the agricultural tasks performed by the two people as data. For example, if one person has a lot of agricultural experience and the other person is a novice with little agricultural experience, the difference between the experienced person and the novice will be evident upon collecting the disparities. For this reason, according to the present embodiment, it is possible to specify mistakes that novices tend to make, and it is possible to suggest a type of educational material corresponding to the result. In other words, according to the present embodiment, it is possible to suggest a suitable type of educational material for learning an agricultural task.

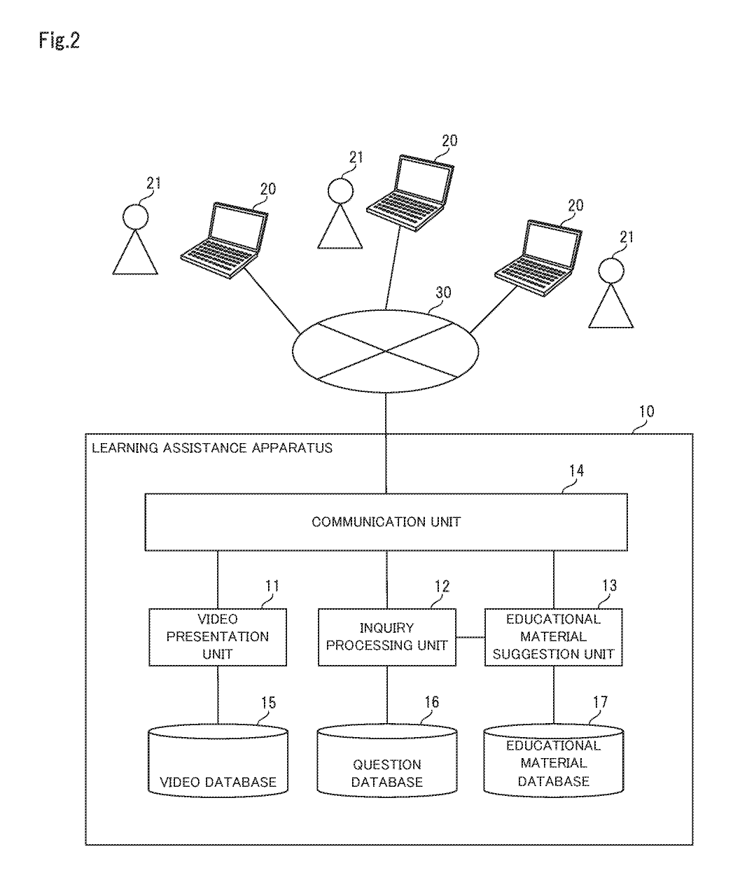

Next, a specific configuration of the learning assistance apparatus 10 according to the present embodiment will be described with reference to FIG. 2. FIG. 2 is a block diagram showing a specific configuration of a learning assistance apparatus according to an embodiment of the present invention.

As shown in FIG. 2, in the present embodiment, the learning assistance apparatus 10 is connected to the terminal apparatus 20 of the user 21 via the network 30. Also, as shown in FIG. 2, the learning assistance apparatus 10 includes a video presentation unit 11, an inquiry processing unit 12, and an educational material suggestion unit 13, as well as a communication unit 14, a video database 15, a question database 16, and an educational material database 17.

The communication unit 14 performs data communication with the terminal apparatus of the user 21 via the network 30. Accordingly, in the present embodiment, presentation of the video by the video presentation unit 11 is performed through the communication unit 14. Similarly, presentation of the questions to the user 21 by the inquiry processing unit 12, reception of the response from the user 21, and suggestion of the type of educational material by the educational material suggestion unit 13 are performed through the communication unit 14.

Also, in the present embodiment, a person with more experience regarding a specific agricultural task than the second person is envisioned as the first person. In other words, in the present embodiment, a person with a lot of agricultural experience is envisioned as the first person and a novice with little agricultural experience is envisioned as the second person. Hereinafter, the first person will be denoted as “experienced person” and the second person will be denoted as “novice”.

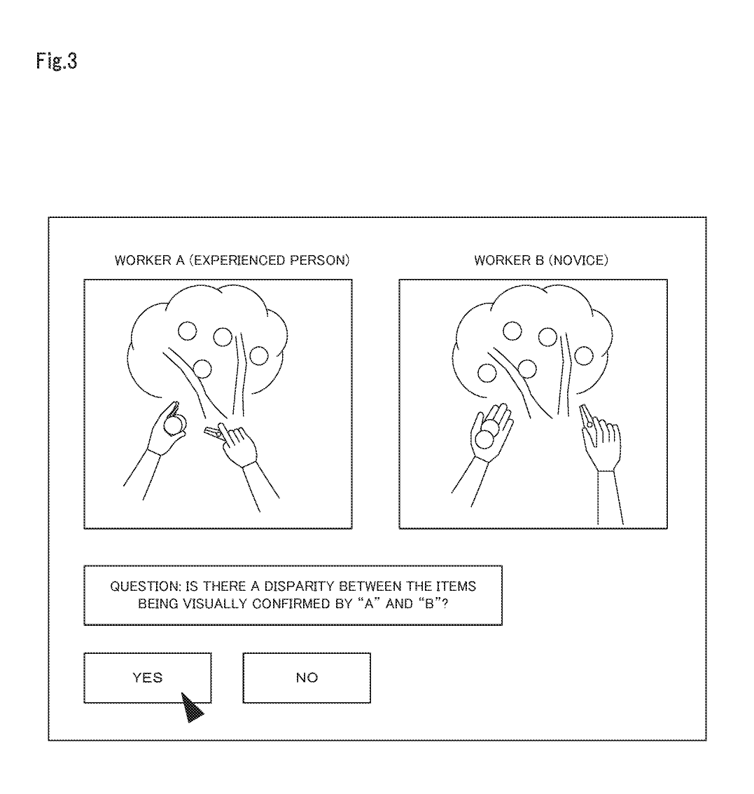

Furthermore, as shown in FIG. 3, for example, videos taken with cameras attached to the heads of the experienced person and the novice are given as examples of the first video and the second video presented in the present embodiment. Since this kind of video is taken from the viewpoint of the creator who is performing the agricultural task, it is useful in the case where the user judges the difference. FIG. 3 is a diagram showing an example of the first and second videos displayed on the terminal apparatus of the user in the present embodiment. In the example of FIG. 3, the specific agricultural task is a task of pruning fruits such as mandarin oranges.

Also, the first video and the second video may be provided using separate video data, or they may be provided using video data in which the two videos are integrated. Note that the video data of the first video and the second video are stored in the video database 15.

In the present embodiment, the video presentation unit 11 uses streaming technology to transmit the video data stored in the video database 15 by the communication unit 14 to the terminal apparatus 20 via the network 30. Accordingly, as shown in FIG. 3, the first video and the second video are presented on the screen of the terminal apparatus 20 of the user 21.

In the present embodiment, as the questions relating to disparities, the inquiry processing unit 12 gives questions about (1) whether or not there is a disparity between items or portions of items being visually confirmed, (2) whether or not there is a disparity between the physical properties being checked, (3) whether or not there is a disparity between changes in line of sight, (4) whether or not there is a disparity between movements of the hands and bodies, and (5) whether or not there is a disparity between the results of the agricultural tasks. The questions are stored in the question database 16. Also, questions (1) to (5) are made into a first question group.

Also, an entire tree, a trunk, a branch, a leaf, weather conditions, soil, and the like are examples of the above-described “item being visually confirmed”. A portion of a tree branch from which a bud is sprouting and the like are examples of a “portion of the item being visually confirmed”. Furthermore, examples of the “physical properties being checked” include the size, color, shape, and moisture amount. Examples of the “results of the agricultural task” include the number of harvested agricultural products, a cross-section of a cut branch, a state of a harvested fruit, the speed of the agricultural task, and the amount of time taken for the agricultural task.

Also, relating to the above-described questions for which there was a disparity, the inquiry processing unit 12 gives questions inquiring (6) whether or not there is a supposed disparity between states that cannot be visually confirmed, (7) whether or not there is a disparity between judgments based on combinations, (8) whether or not there is a disparity between judgments based on a result of visual confirmation, and (9) whether or not there is a disparity between causes of a difference between the results of the agricultural tasks. These questions are also stored in the question database 16. Also, questions (6) to (9) are made into a second question group.

Also, examples of the above-described “state that cannot be visually confirmed” include a state at a future time, such as one month later or one year later, or a state that physically cannot be visually confirmed, such as a state of being underground. Also, examples of the “combination” include combinations such as the northern side and southern side of a tree, or a tree and soil.

Furthermore, in the present embodiment, in the case where a response indicating that there is a disparity is obtained when disparities are inquired about with the above-described first question group and the second question group, the inquiry processing unit 12 further makes an inquiry to the user about the degree of influence that the disparity has on the result of the specific agricultural task (hereinafter simply referred to as “degree of influence”) and the size of the disparity.

Specifically, the inquiry processing unit 12 displays inquiries regarding the degree of influence and the size of the disparity on the screen of the terminal apparatus 20 via the communication unit 14. Also, at this time, the inquiry processing unit 12 inputs the degree of influence and the size of the disparity into the terminal apparatus 20, for example.

Furthermore, input of the degree of influence and the size of the disparity may be performed through input of a specific numerical value, or may be performed through input of a pre-set step-wise level (large, medium, and small, 1 to 5, or the like). Note that in the latter case, the inquiry processing unit 12 converts the levels into specific numerical values in accordance with a predetermined rule in order to perform the later-described processing. Note that examples of rules include a rule in which large=3, medium=2, small=1, and the like.

In the present embodiment, the educational material suggestion unit 13 first specifies the questions among the inquired questions for which disparities were present. Next, the educational material suggestion unit 13 specifies the type of educational material that has been linked to the specific question in advance as the type of educational material for describing the specific agricultural task. Also, many educational materials are registered for each type in the educational material database 17. Accordingly, the educational material suggestion unit 13 can also suggest a specific type and suggest an actual educational material categorized in that type.

Specifically, (a) to (e) below are examples of types of educational materials suggested in the present embodiment.

(a) An educational material that presents a photograph of an agricultural task and causes the user to respond with a point to pay attention to with regard to the agricultural task.
(b) An educational material that presents multiple photographs relating to an agricultural task and causes the user to select the most suitable photograph among them.
(c) An educational material that presents a video of an agricultural task of an experienced person and a video of an agricultural task of a novice simultaneously and indicates the disparity between the two through text.
(d) An educational material that indicates the result of an agricultural task using a field constructed in a virtual space. For example, an educational material that constructs a three-dimensional model of a fruit tree and displays the influence that the result of the agricultural task has on the fruit tree using computer graphics.
(e) An educational material in a manual format in which a judgment reference for the agricultural task, a way of thinking in the case when a problem occurs, specific tasks, and the like are described.

Also, the above-described questions (1) to (9) and the above-described types (a) to (e) of the educational materials are linked as follows, for example.

(1) Disparity between items or portions of items being visually confirmed: (a)
(2) Disparity between physical properties being checked: (a)
(3) Disparity between changes in line of sight: (c)
(4) Disparity between movements of the hands and bodies: (c)
(5) Disparity between the results of the agricultural tasks: (d)
(6) Supposed disparity between states that cannot be visually confirmed: (d)
(7) Disparity between judgments based on combinations: (a), (b), (d), (e)
(8) Disparity between judgments based on results of visual confirmation: (a), (b), (e)
(9) Disparity between causes of a difference between results of agricultural tasks: (c), (e)

Furthermore, in the present embodiment, if there are multiple specified types of educational materials, the educational material suggestion unit 13 sets the priority levels for the suggested types of educational materials based on the degree of influence and size of the disparity of the question to which the specified types of educational materials are linked.

For example, for each specified type of educational material, the educational material suggestion unit 13 multiplies the value of the degree of influence and the value of the size of the disparity of the question to which the specified type of educational material is linked, calculates an importance level, and sets the priority levels for the types of educational materials in order of the size of the value of the importance level. In this case, the educational material suggestion unit 13 makes suggestions in order starting from the type of educational material with the highest priority level. Note that the method for calculating the importance level is not limited to that described above, and any calculation method may be used.

Also, the educational material suggestion unit 13 can set the priority level for the type of educational material by adding the level of ease of creation for each type of educational material to the importance level. For example, the levels of ease of creation for the above-described types of educational materials (a) to (e) are (c)>(e)>(a)(b)>(d), in order starting from the highest. Also, it is assumed that the levels of ease are set as follows for the types of educational materials.

(c): 1.2
(e): 1.0
(a), (b): 0.9
(d): 0.6

In this kind of case, the educational material suggestion unit 13 multiplies the level of ease by the importance level for each type of educational material to correct the importance levels, and sets the priority levels for the types of educational materials in order of the size of the value of the corrected importance level.

Also, if the questions are presented to multiple users 21 and responses are received from the users 21, the educational material suggestion unit 13 specifies the type of educational material for each response. In this case as well, the educational material suggestion unit 13 calculates the importance level for each specified type of educational material, but since there are multiple users 21, the educational material suggestion unit 13 calculates the importance level by multiplying the average value of the degrees of influence input by the users 21 and the average value of the sizes of the disparities input by the users 21. Then, the educational material suggestion unit 13 sets the priority levels for the types of educational materials in order of the size of the importance level obtained based on the average values.

### Operations of Apparatus

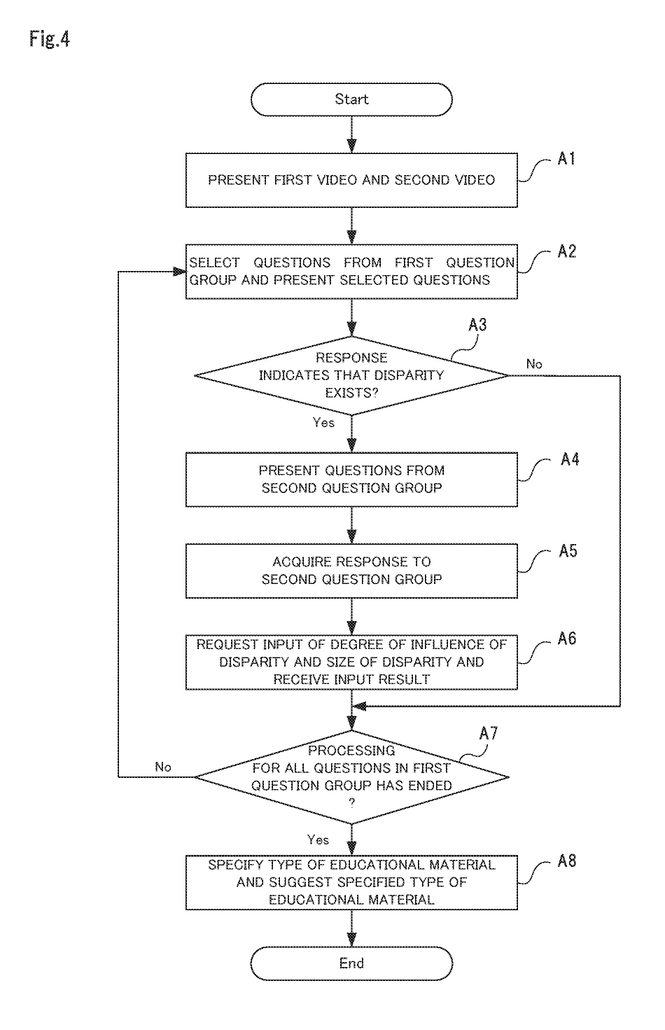

Next, operations performed by the learning assistance apparatus 10 according to the present embodiment will be described with reference to FIG. 4. FIG. 4 is a flow diagram showing operations performed by a learning assistance apparatus according to an embodiment of the present invention. In the following description, FIGS. 1 to 3 will be referenced as needed. In the present embodiment, a learning assistance method is carried out by causing the learning assistance apparatus 10 to operate. Accordingly, the description of the learning assistance method according to the present embodiment will be substituted with the following description of the operations performed by the learning assistance apparatus 10.

As shown in FIG. 4, first, the video presentation unit 11 presents the first video and the second video to the user 21 (step A1). Specifically, the video presentation unit 11 transmits the video data stored in the video database 15 by the communication unit 14 to the terminal apparatus 20 of the user 21 via the network 30. Accordingly, the first video and the second video are presented on the screen of the terminal apparatus 20 (see FIG. 3).

Next, the inquiry processing unit 12 selects one question among the first question group and presents the selected question to the user (step A2). Specifically, the inquiry processing unit 12 extracts the data of the question selected from the question database 16 and transmits the extracted data by the communication unit 14 to the terminal apparatus 20 of the user 21 via the network 30. Accordingly, the question is presented on the screen of the terminal apparatus 20 (see FIG. 3).

Next, the inquiry processing unit 12 determines whether or not the user 21 responded that there is a disparity in response to the question (step A3). If it is determined in step A3 that the user did not respond that there is a disparity, later-described step A7 is executed.

On the other hand, if it is determined in step A3 that the user has responded that there is a disparity, the inquiry processing unit 12 presents the questions in the second question group (step A4). Specifically, the inquiry processing unit 12 extracts the data of the second question group from the question database 16 and transmits the extracted data by the communication unit 14 to the terminal apparatus 20 of the user 21 via the network 30. Accordingly, the second question group is presented on the screen of the terminal apparatus 20.

Next, the inquiry processing unit 12 acquires the responses to the second question group from the user 21 from the terminal apparatus 20 that presented the second question group, via the network 30 (step A5). Next, on the terminal apparatus 20, the inquiry processing unit 12 requests input of a degree of influence and a size of the disparity to the user 21 in response to the response indicating that there is a disparity in the first question group and the second question group, and receives the input result (step A6).

Next, the inquiry processing unit 12 determines whether or not the processing for all of the questions in the first question group has ended (step A7). If it is determined in step A7 that the processing for all of the questions has not ended, step A2 is executed once again. On the other hand, if it is determined in step A7 that the processing for all of the questions has ended, the response result and the input result transmitted from the terminal apparatus 20 of the user 21 are transferred to the educational material suggestion unit 13.

Next, the educational material suggestion unit 13 specifies the appropriate type of educational material based on the response result and input result transmitted from the terminal apparatus 20 of the user 21, and the specified type of educational material is suggested (step A8).

Specifically, the educational material suggestion unit 13 specifies the questions among the inquired questions for which there were disparities. Next, the educational material suggestion unit 13 specifies the type of educational material that has been linked to the specified question in advance as the type of educational material for describing the specific agricultural task. Also, if there are multiple specified types of educational materials, the educational material suggestion unit 13 sets the priority levels for the suggested types of educational materials based on the degree of influence and size of the disparity of the question to which the specified types of educational materials are linked, and suggests the types of educational materials in order of the priority level. Furthermore, the educational material suggestion unit 13 suggests the specified types, acquires actual educational materials categorized in those types from the educational material database, and suggests the acquired educational materials.

As described above, according to the present embodiment, the disparities between the experienced person and the novice are collected, and the disparities between the experienced person and the novice become evident, and therefore it is possible to specify mistakes that novices tend to make and to suggest types of educational materials corresponding to the result. Also, with the present embodiment, if there are multiple types of educational materials that are candidates for suggestion, the priority levels can be set for the types of educational materials, and therefore a learner can efficiently learn agricultural tasks.

### Program

A program according to the present embodiment need only be a program that causes a computer to execute steps A1 to A8 shown in FIG. 4. By installing the program on a computer and executing it, it is possible to realize the learning assistance apparatus 10 and the learning assistance method according to the present embodiment. In this case, the CPU (Central Processing Unit) of the computer functions as the video presentation unit 11, the inquiry processing unit 12, and the educational material suggestion unit 13, and performs processing.

Also, in the present embodiment, the video database 15, the question database 16, and the educational material database 17 can be realized by storing data files constituting them in a storage apparatus such as a hard disk included in a computer.

Furthermore, the program according to the present embodiment may be executed by a computer system constructed using multiple computers. In this case, for example, each computer may function as one of the video presentation unit 11, the inquiry processing unit 12, and the educational material suggestion unit 13. In addition, the video database 15, the question database 16, and the educational material database 17 may be constructed in a computer other than the computer that executes the program according to the present embodiment.

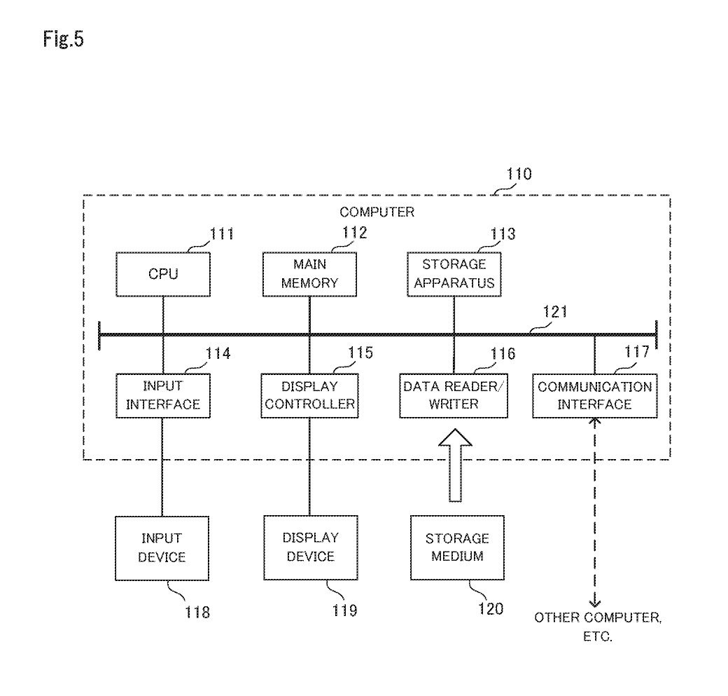

Here, a computer that realizes the learning assistance apparatus 10 by executing the program according to the present embodiment will be described with reference to FIG. 5. FIG. 5 is a block diagram showing an example of a computer that realizes the learning assistance apparatus according to an embodiment of the present invention.

As shown in FIG. 5, the computer 110 includes a CPU 111, a main memory 112, a storage device 113, an input interface 114, a display controller 115, a data reader/writer 116, and a communication interface 117. These units are connected to each other via a bus 121 so as to be able to perform data communication.

The CPU 111 carries out various calculations by expanding programs (codes) according to the present embodiment, which are stored in the storage device 113, to the main memory 112 and executing them in a predetermined sequence. The main memory 112 is typically a volatile storage device such as a DRAM (Dynamic Random Access Memory). Also, the program according to the present embodiment is provided in a state of being stored in a computer-readable storage medium 120. Note that the program according to the present embodiment may be distributed over the Internet, which is connected to via the communication interface 117.

Also, specific examples of the storage device 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119 and controls display on the display device 119.

The data reader/writer 116 mediates data transmission between the CPU 111 and the storage medium 120, reads out programs from the storage medium 120, and writes results of processing performed by the computer 110 in the storage medium 120. The communication interface 117 mediates data transmission between the CPU 111 and another computer.

Also, specific examples of the storage medium 120 include a general-purpose semiconductor storage device such as CF (Compact Flash (registered trademark)) and SD (Secure Digital), a magnetic storage medium such as a flexible disk, and an optical storage medium such as a CD-ROM (Compact Disk Read Only Memory).

Note that the learning assistance apparatus 10 according to the present embodiment can also be executed by using hardware corresponding to the units instead of with a computer on which the program is installed. Furthermore, a portion of the learning assistance apparatus 10 may be realized by a program, and the rest may be realized by hardware.

A portion or all of the above-described embodiment can be expressed using Supplementary Note 1 to Supplementary Note 15 described below, but there is no limitation to the following description.

### Supplementary Note 1

A learning assistance apparatus including:

a video presentation unit configured to present a first video of a first person performing a specific agricultural task and a second video of a second person performing the specific agricultural task;

an inquiry processing unit configured to present, to a user, questions regarding disparities between the agricultural task of the first person in the first video and the agricultural task performed by the second person in the second video, and receive a response of the user; and

an educational material suggestion unit configured to specify a type of educational material for describing the specific agricultural task based on the result of the response, and suggest the specified type of educational material.

### Supplementary Note 2

The learning assistance apparatus according to Supplementary Note 1, wherein

as the questions regarding the disparities, the inquiry processing unit gives questions inquiring whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and

in relation to a question for which there was a disparity,

further gives questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks.

### Supplementary Note 3

The learning assistance apparatus according to Supplementary Note 2, wherein

among the questions, the educational material suggestion unit specifies a question for which there was a disparity, and further specifies a type of educational material linked to the specified question in advance as the type of educational material for describing the specific agricultural task.

### Supplementary Note 4

The learning assistance apparatus according to Supplementary Note 3, wherein

if a response indicating that there is a disparity is obtained when disparities are inquired about in the questions, the inquiry processing unit furthermore inquires about a degree of influence that the disparity has on the result of the specific agricultural task, and about the size of the disparity, and

if a plurality of said specified educational materials exist, the educational material suggestion unit sets priority levels for the types of educational materials to be suggested based on the degree of influence and the size of the disparity in the question to which the specified types of educational materials are linked.

### Supplementary Note 5

The learning assistance apparatus according to any one of Supplementary Notes 1 to 4, wherein

the first person is more experienced in the specific agricultural task than the second person.

### Supplementary Note 6

A learning assistance method including:

(a) a step of presenting a first video of a first person performing a specific agricultural task and a second video of a second person performing the specific agricultural task;

(b) a step of presenting, to a user, questions regarding disparities between the agricultural task of the first person in the first video and the agricultural task performed by the second person in the second video, and receiving a response of the user; and

(c) a step of specifying a type of educational material for describing the specific agricultural task based on the result of the response, and suggesting the specified type of educational material.

### Supplementary Note 7

The learning assistance method according to Supplementary Note 6, wherein

in the step (b), as the questions regarding the disparities, questions are given which inquire whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and

in relation to a question for which there was a disparity,

questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks are further given.

### Supplementary Note 8

The learning assistance method according to Supplementary Note 7, wherein

in the step (c), among the questions, a question for which there was a disparity is specified, and a type of educational material linked to the specified question in advance is specified as a type of educational material for describing the specific agricultural task.

### Supplementary Note 9

The learning assistance method according to Supplementary Note 8, wherein

(d) a step of, if a response indicating that there is a disparity is obtained when disparities are inquired about in the questions in the step (b), further inquiring about a degree of influence that the disparity has on the result of the specific agricultural task, and about the size of the disparity,

wherein if a plurality of said specified educational materials exist in the step (c), the priority levels for the types of educational materials to be suggested are set based on the degree of influence and the size of the disparity in the question to which the specified types of educational materials are linked.

### Supplementary Note 10

The learning assistance method according to any one of Supplementary Notes 6 to 9, wherein

the first person is more experienced in the specific agricultural task than the second person.

### Supplementary Note 11

A computer-readable storage medium storing a program that includes commands for causing a computer to execute:

(a) a step of presenting a first video of a first person performing a specific agricultural task and a second video of a second person performing the specific agricultural task;

(b) a step of presenting, to a user, questions regarding disparities between the agricultural task of the first person in the first video and the agricultural task performed by the second person in the second video, and receiving a response of the user; and

(c) a step of specifying a type of educational material for describing the specific agricultural task based on the result of the response, and suggesting the specified type of educational material.

### Supplementary Note 12

The computer-readable storage medium according to Supplementary note 11, wherein

in the step (b), as the questions regarding the disparities, questions are given which ask whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and

in relation to a question for which there was a disparity,

questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks are further given.

### Supplementary Note 13

The computer-readable storage medium according to Supplementary Note 12, wherein

in the step (c), among the questions, a question for which there was a disparity is specified, and a type of educational material linked to the specified question in advance is specified as a type of educational material for describing the specific agricultural task.

### Supplementary Note 14

The computer-readable storage medium according to Supplementary Note 13, wherein

the program includes commands for causing the computer to further execute

(d) a step of, if a response indicating that there is a disparity is obtained when disparities are inquired about in the questions, further inquiring about a degree of influence that the disparity has on the result of the specific agricultural task, and about the size of the disparity in the step (b),

wherein if a plurality of said specified educational materials exist in the step (c), the priority levels for the types of educational materials to be suggested are set based on the degree of influence and the size of the disparity in the question to which the specified types of educational materials are linked.

### Supplementary Note 15

The computer-readable storage medium according to any one of Supplementary notes 11 to 14, wherein

the first person is more experienced in the specific agricultural task than the second person.

As described above, with the present invention, it is possible to suggest a suitable type of educational material for learning agricultural tasks. The present invention is useful for learning technical skills and know-how in the agriculture field.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A learning assistance apparatus comprising
a computer,
wherein a processor of the computer functions as:
a video presentation unit configured to present a first video of a first person performing a specific agricultural task and a second video of a second person performing the specific agricultural task;
an inquiry processing unit configured to present, to a user, questions regarding disparities between the agricultural task of the first person in the first video and the agricultural task performed by the second person in the second video, and receive a response of the user; and
an educational material suggestion unit configured to specify a type of educational material for describing the specific agricultural task based on the result of the response, and suggest the specified type of educational material.

2. The learning assistance apparatus according to claim 1, wherein
as the questions regarding the disparities, the inquiry processing unit gives questions inquiring whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and
in relation to a question for which there was a disparity,
further gives questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks.

3. The learning assistance apparatus according to claim 2, wherein
among the questions, the educational material suggestion unit specifies a question for which there was a disparity, and further specifies a type of educational material linked to the specified question in advance as the type of educational material for describing the specific agricultural task.

4. The learning assistance apparatus according to claim 3, wherein
if a response indicating that there is a disparity is obtained when disparities are inquired about in the questions, the inquiry processing unit furthermore inquires about a degree of influence that the disparity has on the result of the specific agricultural task, and about the size of the disparity, and
if a plurality of said specified educational materials exist, the educational material suggestion unit sets priority levels for the types of educational materials to be suggested based on the degree of influence and the size of the disparity in the question to which the specified types of educational materials are linked.

5. The learning assistance apparatus according to claim 1, wherein
the first person is more experienced in the specific agricultural task than the second person.

6. A learning assistance method executed by a computer, the method comprising:
(a) a step of presenting a first video of a first person performing a specific agricultural task and a second video of a second person performing the specific agricultural task;
(b) a step of presenting, to a user, questions regarding disparities between the agricultural task of the first person in the first video and the agricultural task performed by the second person in the second video, and receiving a response of the user; and
(c) a step of specifying a type of educational material for describing the specific agricultural task based on the result of the response, and suggesting the specified type of educational material.

7. The learning assistance method according to claim 6, wherein
in the step (b), as the questions regarding the disparities, questions are given which inquire whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and
in relation to a question for which there was a disparity,
questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks are further given.

8. The learning assistance method according to claim 7, wherein
in the step (c), among the questions, a question for which there was a disparity is specified, and a type of educational material linked to the specified question in advance is specified as a type of educational material for describing the specific agricultural task.

9. The learning assistance method according to claim 8, further comprising
(d) a step of, if a response indicating that there is a disparity is obtained when disparities are inquired about in the questions in the step (b), further inquiring about a degree of influence that the disparity has on the result of the specific agricultural task, and about the size of the disparity,
wherein if a plurality of said specified educational materials exist in the step (c), the priority levels for the types of educational materials to be suggested are set based on the degree of influence and the size of the disparity in the question to which the specified types of educational materials are linked.

10. The learning assistance method according to claim 6, wherein
the first person is more experienced in the specific agricultural task than the second person.

11. A non-transitory computer-readable storage medium storing a program that includes commands for causing a computer to execute:
(a) a step of presenting a first video of a first person performing a specific agricultural task and a second video of a second person performing the specific agricultural task;
(b) a step of presenting, to a user, questions regarding disparities between the agricultural task of the first person in the first video and the agricultural task performed by the second person in the second video, and receiving a response of the user; and
(c) a step of specifying a type of educational material for describing the specific agricultural task based on the result of the response, and suggesting the specified type of educational material.

12. The non-transitory computer-readable storage medium according to claim 11, wherein
in the step (b), as the questions regarding the disparities, questions are given which ask whether or not there is a disparity between items or portions of the items being visually confirmed, whether or not there is a disparity between physical properties being checked, whether or not there is a disparity between changes in line of sight, whether or not there is a disparity between movements of hands and bodies, and whether or not there is a disparity between results of agricultural tasks, and
in relation to a question for which there was a disparity,
questions inquiring whether or not there is a supposed disparity between states that cannot be visually confirmed, whether or not there is a disparity between judgments based on combinations, whether or not there is a disparity between judgments based on results of visual confirmation, and whether or not there is a disparity between causes of a difference in results of agricultural tasks are further given.

13. The non-transitory computer-readable storage medium according to claim 12, wherein
in the step (c), among the questions, a question for which there was a disparity is specified, and a type of educational material linked to the specified question in advance is specified as a type of educational material for describing the specific agricultural task.

14. The non-transitory computer-readable storage medium according to claim 13, wherein
the program includes commands for causing the computer to further execute
(d) a step of, if a response indicating that there is a disparity is obtained when disparities are inquired about in the questions, further inquiring about a degree of influence that the disparity has on the result of the specific agricultural task, and about the size of the disparity in the step (b),
wherein if a plurality of said specified educational materials exist in the step (c), the priority levels for the types of educational materials to be suggested are set based on the degree of influence and the size of the disparity in the question to which the specified types of educational materials are linked.

15. The non-transitory computer-readable storage medium according to claim 11, wherein
the first person is more experienced in the specific agricultural task than the second person.
